(19) United States
(12) Patent Application Publication
(10) Pub. No.: US 2003/0207057 A1
(43) Pub. Date: Nov. 6, 2003

(54) Metered dose inhaler can coated two or more times with fluorocarbon polymers

(76) Inventors: Ignatius Loy Britto, Evreaux (FR); William McHale, Oxford, PA (US); Laurence McKeen, Washington, NJ (US); Michael Witsch, Folcroft, PA (US)

Correspondence Address: BIRCH STEWART KOLASCH & BIRCH, PO BOX 747, FALLS CHURCH, VA, 22040-0747, US

(21) Appl. No.: 10/380,625

(22) PCT Filed: Sep. 18, 2001
(86) PCT No.: PCT/US01/29080

(30) Foreign Application Priority Data
Sep. 18, 2000 (US) 60233135

(51) Int. Cl. B65D 1/00; B05D 3/02; B05D 1/36

(52) U.S. Cl. 428/35.7; 427/384; 427/402

(57) ABSTRACT

A metered dose inhaler having part or all of its internal surfaces coated two or more times with a polymer comprising one or more fluorocarbon polymers, optionally in combination with one or more non-fluorocarbon polymers, containing an inhalation drug or a physiologically acceptable salt thereof, optionally an excipient and a fluorocarbon propellant. Also, a method for coating all or part of internal surfaces of a metered dose inhaler can comprising applying a first coat comprising a one or more fluorocarbon polymers to all or part of the internal the surfaces of a metered dose inhaler can. Subsequently, heating the first coat of fluorocarbon polymer and then applying a second coat comprising one or more fluorocarbon polymer on top of the first coat of fluorocarbon polymer. The two coats of fluorocarbon polymer are then heated to give a metered dose inhaler can that is more efficient in dispensing consistent doses of aerosol formulations.

### FIELD OF INVENTION

The field of the invention is making a metered dose inhaler that provides for a consistent dispensing of an aerosol pharmaceutical formulation.

### DESCRIPTION OF RELATED ART

Drugs for treating respiratory and nasal disorders are frequently administered in aerosol formulations through the mouth or nose. One widely used method for dispensing such aerosol drug formulations involves making a suspension formulation of the drug as a finely divided powder in a liquefied gas known as a propellant. The suspension is stored in a sealed container capable of withstanding the pressure required to maintain the propellant as a liquid. The suspension is dispersed by activation of a dose-metering valve affixed to the container.

A metering valve may be designed to consistently release a fixed, predetermined mass of the drug formulation upon each activation. As the suspension is forced from the container through the dose-metering valve by the high vapor pressure of the propellant, the propellant rapidly vaporizes leaving a fast moving cloud of very fine particles of the drug formulation. This cloud of particles is directed into the nose or mouth of the patient by a channeling device such as a cylinder or open-ended cone. Concurrently with the activation of the aerosol dose-metering valve, the patient inhales the drug particles into the lungs or nasal cavity. Systems of dispensing drugs in this way are known as “metered dose inhalers” (MDI's). See Peter Byron, Respiratory Drug Delivery, CRC Press, Boca Raton, Fla. (1990) for a general background on this form of therapy.

Patients often rely on medication delivered by MDI's for rapid treatment of respiratory disorders that are debilitating and in some cases, even life threatening. Therefore, it is essential that the prescribed dose of aerosol medication delivered to the patient consistently meets the specifications claimed by the manufacturer and complies with the requirements of the FDA and other regulatory authorities. That is, every dose in the MDI must be the same within close tolerances.

Some aerosol drugs tend to adhere to the inner surfaces, i.e., walls of the can, valves, and caps, of the MDI. This can lead to the patient getting significantly less than the prescribed amount of drug upon each activation of the MDI. The problem is particularly acute with hydrofluoroalkane (also known as simply “fluorocarbon”) propellant systems, e.g., P134a and P227, under development in recent years to replace chlorofluorocarbons such as P11 and P12.

Metered dose inhaler cans are well known in the art. Two publications of particular relevance disclose methods to prevent significant deposits of the active substances on the inner walls of metered dose inhaler cans.

Published application for Canadian patent (CA 2,130,807) discloses an aerosol container for pharmaceutically active aerosols. The publication discloses coating the inner wall of the aerosol container with a plastic coating. Polytetrafluoroethylene is given as being a suitable material for use as a plastic coating.

WO 96/32099 discloses a metered dose inhaler for α¹-tert-butylaminomethyl-4-hydroxy-m-xylene-α¹, α³-diol, also known in the United States by its generic name “albuterol”. The reference discloses coating the inner surfaces of metered dose inhaler can with fluorocarbon polymer or a blend of fluorocarbon polymer and a non-fluorocarbon polymer.

### BRIEF SUMMARY OF THE INVENTION

The present invention is directed to a method for coating all or part of internal surfaces of a metered dose inhaler, comprising:

applying a first coat comprising a fluorocarbon polymer to all or part of the internal the surfaces of a metered dose inhaler;

heating the first coat of fluorocarbon polymer;

applying a second coat comprising a fluorocarbon polymer on top of the first coat of fluorocarbon polymer;

heating the second coat of fluorocarbon polymer; and

optionally, applying additional coats of a fluorocarbon polymer followed by heating steps.

It has been found that coating the interior can surfaces of MDI's two or more times with a fluorocarbon polymer, reduces or essentially eliminates the problem of drug adhesion or deposition on the can walls and thus ensures consistent delivery of medication in aerosol form from the MDI.

### DETAILED DESCRIPTION OF THE INVENTION

The term “metered dose inhaler” or “MDI” means a unit comprising a can, a crimped cap covering the mouth of the can, and a drug metering valve situated in the cap, while the term “MDI system” also includes the actuating device. The term “MDI can” means the container without the cap and valve. The term “drug metering valve” or “MDI valve” refers to a valve and its associated mechanisms, which delivers a predetermined amount of drug formulation from an MDI upon each activation. The relation of the parts of a typical MDI is illustrated in U.S. Pat. No. 5,261,538 incorporated herein by reference.

The term “drug formulation” means a drug or salt thereof suitable to be formulated as an aerosol, optionally in combination with one or more other pharmacologically active agents such as anti-inflammatory agents, analgesic agents or other respiratory drugs and optionally containing one or more excipients. The term “excipients” as used herein mean chemical agents having little or no pharmacological activity for the quantities used, but the chemical agents enhance the drug formulation or the performance of the MDI system. For example, excipients include but are not limited to surfactants, preservatives, flavorings, antioxidants, antiaggregating agents, and cosolvents, e.g., ethanol and diethyl ether.

Drugs useful in this invention should be in solid particulate form typically with a mass median aerodynamic diameter under 100 microns, preferably under 20 microns. Drugs, or medicaments, appropriate for this invention include those drugs adaptable to inhalation administration, for example, antiallergenic, respiratory (e.g., antiasthmatic and bronchodilating), antibiotic, anti-inflammatory, antifungal, analgesic, antiviral, and cardiovascular drugs. Where appropriate, the drugs may be used in the form of salts (e.g., as alkali metal or amine salts or as acid addition salts), or as esters (e.g. as lower alkyl esters).

Medicaments may be selected from, for example, analgesics, e.g. codeine, dihydromorphine, ergotamine, fentanyl or morphine, anginal preparations, e.g., diltiazem; antiallergics, e.g., cromoglycate, ketotifen or nedocromil; antiinfectives e.g., cephalosporins, penicillins, streptomycin, sulphonamides, tetracyclines and pentamidine; antihistamines, e.g., methapyrilene; anti-inflammatories, e.g. beclomethasone (e.g., the dipropionate), flunisolide, budesonide, tipredane or triamcinolone acetonide; antitussives, e.g., noscapine; bronchodilators, e.g., salbutamol, salmeterol, ephedrine, adrenaline, fenoterol, formoterol, isoprenaline, metaproterenol, phenylephrine, phenylpropanolamine, pirbuterol, reproterol, rimiterol, terbutaline, isoetharine, tulobuterol, orciprenaline, or (−)-4-amino-3,5-dichloro-α-[[[6-[2-(2-pyridinyl)ethoxy]hexyl]-amino]methyl]benzene-methanol; diuretics, e.g., amiloride; anticholinergics e.g., ipratropium, atropine or oxitropium; hormones, e.g., cortisone, hydrocortisone or prednisolone; xanthines e.g., aminophylline, choline theophyllinate, lysine theophyllinate or theophylline; and therapeutic proteins and peptides, e.g., insulin or glucagon. It will be clear to a person skilled in the art that, where appropriate, the medicaments may be used in the form of salts (e.g., as alkali metal or amine salts or as acid addition salts) or as esters (e.g., lower alkyl esters) or as solvates (e.g., hydrates) to optimise the activity and/or stability of the medicament and/or to minimize the solubility of the medicament in the propellant.

The drug is typically included in the aerosol compositions of the present invention in an amount of between 0.005% and 10.0% by weight of the total weight of the composition.

Preferred drugs and drug combinations are disclosed in WO 96/32151, WO 96/32345, WO 96/32150 and WO 96/32099, the entire contents of which are hereby incorporated by reference. These drugs include, for example, fluticasone propionate or a physiologically acceptable solvate thereof, beclomethasone dipropionate or a physiologically acceptable solvate thereof, salmeterol or a physiologically acceptable salt thereof and albuterol or a physiologically acceptable salt thereof. These drugs are also are described in U.S. Pat. Nos. 4,992,474, 4,335,121, 3,644,363 and 3,312,590.

U.S. Pat. No. 4,992,474, incorporated herein by reference, teaches a bronchodilating compound particularly useful in the treatment of asthma and other respiratory diseases known by the chemical name 4-hydroxy-alpha′-(((6-(4-phenylbutoxy)hexyl)amino)methyl)-1,3-benzenemethanol and the generic name “salmeterol”. Salmeterol as the free base and as acid addition salts, particularly as the 1-hydroxy-2-naphthalenecarboxylic acid salt also know as “hydroxynaphthoate”, especially in aerosol form, has been accepted by the medical community as a useful treatment of asthma and is marketed under the trademark “Serevent”.

U.S. Pat. No. 4,335,121, incorporated herein by reference, teaches an anti-inflammatory steroid compound known by the chemical name [(6a, 11b, 16a, 17a)-6, 9-difluoro-11-hydroxy-16-methyl-3-oxo-17-(1-oxopropoxy) androsta-1, 4-diene-17-carbothioic acid, S-fluoromethyl ester and the generic name “fluticasone propionate”. Fluticasone propionate, in aerosol form, has been accepted by the medical community as useful in the treatment of asthma and is marketed under the trademarks “Flovent” and “Flonase”.

U.S. Pat. No. 3,644,363, incorporated herein by reference, teaches a group of bronchodilating compounds that are particularly useful in the treatment of asthma and other respiratory diseases. The preferred compound taught therein is α¹-tert-butylaminomethyl-4-hydroxy-m-xylene-α¹, α³-diol, also known in the United States by its generic name “albuterol” and, in most other countries as “salbutamol.” Albuterol as the free base and as acid addition salts, particularly as the sulfate salt, especially in aerosol form, has been widely accepted by the medical community in the treatment of asthma and is marketed under such trademarks as “Ventolin” and “Proventil”.

U.S. Pat. No. 3,312,590, incorporated herein by reference, teaches an anti-inflammatory steroid compound know by the chemical name 9-chloro-11β, 17, 21-trihydroxy-16β-methylprergna-1,4-diene-3, 20-dione 17, 21-dipropionate and the generic name “beclomethasone dipropionate”. Beclomethasone dipropionate, in aerosol form, has been accepted by the medical community as useful in the treatment of asthma and is marketed under the trademarks “Beclovent”, “Becotide”, and “Beconase”.

As excipients, suitable surfactants are generally known in the art, for example, those surfactants disclosed in European Patent Application No. 0327777. The amount of surfactant employed is desirably in the range of 0.0001% to 50% weight to weight ratio relative to the drug, in particular, 0.05 to 5% weight to weight ratio. A particularly useful surfactant is 1,2-di(7-(F-hexyl) hexanoyl)-glycero-3-phospho-N,N,N-trimethylethanolamine also know as 3, 5, 9-trioxa-4-phosphadocosan-1-aminium, 17, 17, 18, 18, 19, 19, 20, 20, 21, 21, 22, 22, 22-tridecafluoro-7-((8, 8, 9, 9, 10, 10, 11, 11, 12, 12, 13, 13, 13-tridecafluoro-1-oxotridecyl)oxy)-4-hydroxy-N, N, N-trimethyl-10-oxo-, inner salt, 4-oxide.

“Propellants” used herein mean pharmacologically inert liquids with boiling points from about room temperature (25° C.) to about −25° C. and exerting a high vapor pressure at room temperature. Upon activation of the MDI system, the high vapor pressure of the propellant in the MDI forces a metered amount of drug formulation out through the metering valve. Then the propellant very rapidly vaporizes dispersing the drug particles. The propellants used in the present invention are low boiling fluorocarbons; in particular, 1,1,1,2-tetrafluoroethane also known as “propellant 134a” or “P 134a” and 1,1,1,2,3,3,3-heptafluoropropane also know as “propellant 227” or “P 227”.

Most often the MDI can and cap are made of aluminum or an alloy of aluminum, although other metals not affected by the drug formulation, such as stainless steel or an alloy of copper, may be used. An MDI may also be fabricated from glass or plastic. The MDI can be strengthened to withstand the stressful baking conditions by employing thicker walls (thickness >0.5 mm) and/or employing a special geometry, such as an ellipsoidal base. The drug-metering valve consists of parts usually made of stainless steel, a pharmacologically inert and propellant resistant polymer, such as acetal, polyamide (e.g., Nylon®), polycarbonate, polyester, fluorocarbon polymer (e.g., Teflon®) or a combination of these materials. Additionally, seals and “O” rings of various materials, e.g., nitrile rubbers, polyurethane, acetyl resin, fluorocarbon polymers, or other elastomeric materials are employed in and around the valve.

In particular, an important aspect of the present invention is an MDI can with internal surfaces coated two or more times with a fluorocarbon polymer, preferably a perfluorocarbon polymer. Suitable fluorocarbon polymers are made from multiples of the following monomeric units: tetrafluoroethylene (TFE; which is used to prepare polytetrafluoroethylene (PTFE), perfluorinated ethylene propylene (FEP; which is perfluorinated ethylene propylene copolymer, which is a copolymer of TFE and hexafluoropropylene (HFP)), perfluoroalkoxyalkylene (PFA; which is perfluoroalkoxy fluorocarbon polymer which is prepared using perfluoroalkyl vinyl ether monomer), ethylene tetrafluoroethylene (ETFE; ethylene-tetrafluoroethylene copolymer), vinylidene fluoride (PVDF; polyvinylidene fluoride), and chlorinated ethylene tetrafluoroethylene, a copolymer made by copolymerizing chlorinated ethylene and tetrafluoroethylene. The fluorocarbon polymer may be blended with non-fluorocarbon polymers such as polyamides, polyimides, polyamideimdie, polyethersulfones and polyphenylene sulfides. The two or more coats of polymer compounds may be of different polymer compounds, but preferably, the coats are the same polymer compounds. However, one of the advantages of the present invention is that an acceptable coating quality can be achieved without blending the fluorocarbon polymer with a non-fluorocarbon polymer.

The MDI can be coated two or more times with polytetrafluoroethylene-polyethersulfone (PTFE-PES), fluorinated ethylene propylene (FEP), or fluorinated ethylene propylene-polytetrafluoroethylene-polyamidimide (PTFE-FEP-PAI) and the MDI can is aluminum or an alloy thereof. Fluorocarbon polymers are marketed under trademarks such as Teflon®, Tefzel®, and Halar®. The coating thickness is in the range of about 0.1 m to about 25 μm per layer of the coating, preferably about 5 μm.

The particle size of the particular, e.g., micronised, drug should be such as to permit inhalation of substantially all the drug into the lungs upon administration of the aerosol formulation and will thus be less than 100 microns, desirably less than 20 microns, and preferably in the range of 1-10 microns, e.g., 1-5 microns.

The final aerosol formulation desirably contains 0.005-10% weight to weight ratio, in particular 0.005-5% weight to weight ratio, especially 0.01-1.0% weight to weight ratio, of drug relative to the total weight of the formulation.

A further aspect of the present invention is a metered dose inhaler having part or all of its internal metallic surfaces coated two or more times with one or more fluorocarbon polymers, optionally in combination with one or more non-fluorocarbon polymers, for dispensing an inhalation drug formulation comprising an aerosol drug or salt thereof and a fluorocarbon propellant optionally in combination with one or more pharmacologically active agents and one or more excipients.

In particular the present invention is an MDI comprising a MDI can having essentially all of its internal metallic surfaces twice coated with FEP for dispensing an aerosol formulation consisting essentially of a drug or pharmacological salt thereof, optionally an excipient, and P 134a.

The MDI's taught herein may be prepared by methods of the art (e.g., see Byron, above and U.S. Pat. No. 5,345,980) substituting conventional cans for those coated with a fluorinated polymer. That is, drug or a salt thereof and other components of the formulation are filled into an aerosol can coated two or more times with a fluorocarbon polymer. The can is fitted with a cap assembly that is crimped in place. The suspension of the drug in the fluorocarbon propellant in liquid form may be introduced through the metering valve as taught in U.S. Pat. No. 5,345,980 incorporated herein by reference.

The MDI's with fluorocarbon coated interiors taught herein may be used in medical practice in a similar manner as non-coated MDI's now in clinical use. However, the MDI's taught herein are particularly useful for containing and dispensing inhaled drug formulations with hydrofluoroalkanefluorocarbon propellants such as 134a with little, or essentially no, excipient and which tend to deposit or cling to the interior walls and parts of the MDI system. In certain cases, it is advantageous to dispense an inhalation drug with essentially no excipient, e.g., where the patient may be allergic to an excipient or the drug reacts with an excipient.

Preparation for Coating MDI Cans:

The uncoated MDI cans may be optionally cleaned prior to coating by heating, for example, in an annealing oven or a plasma oven, using oxygen. The temperature of heating and the time period of heating should be sufficient to prepare the surface of the uncoated MDI cans for coating application by removing residual drawing oils and cleaning agents on the surface of uncoated cans. Cleaning of the uncoated MDI cans, may improve coating quality and adhesion. The temperature range for the annealing oven is about 100 to about 350® C., preferably about 200 to 300° C. The uncoated MDI cans are placed in the oven for about 1.0 to about 5.4 minutes, preferably for about 2.00 to about 4.00 minutes.

Application of Fluorocarbon Polymer to MDI Cans:

The MDI cans are coated by any means known in the art of metal coating. For example, a metal, such as aluminum or stainless steel, may be precoated as coil stock and cured before being stamped or drawn into the can shape. Other techniques for obtaining MDI coated cans is by electrostatic dry powder coating or by spraying preformed MDI cans on their inner surface with formulations comprising the fluorinated polymer, preferably using an air-atomization spray coating process, and then applying heat. The preformed MDI cans may also be dipped in the fluorocarbon polymer coating formulation and then heated, thus becoming coated on the inside and out. The fluorocarbon polymer formulation may also be poured inside the MDI cans and then drained leaving the insides coated with the polymer.

Heating

The term “heating” is defined as raising the temperature of the substrate sufficiently to cause a desired effect. The heating temperature will usually be in the temperature range of 100° C. to 380° C. for a time of 1 to 9 minutes. The term “heating” includes “prebaking” and “final baking”.

Prebake

The term “prebake” defines the process that takes place after applying a coat of fluorocarbon polymer on the MDI cans. The MDI cans are transported to a heated prebaking oven prebaked at a temperature for a time period sufficient to allow nearly all of the solvents contained within the coated film to evaporate. The temperature range for the prebaking oven is usually about 100 to about 200° C., preferably any temperature within the range of about 150 to 200° C. The MDI cans are usually placed in the prebaking oven for a time period of about 1.25 to about 4.4 minutes, preferably about 3.0 to 4.0 minutes. The prebaking oven is purged continuously with forced air, which goes through a filter, to remove the solvent laden atmosphere within the oven.

Final Bake

The term “final bake” defines the process that takes place after a “prebaking” step. The final bake step is preformed at a temperature and for a time period sufficient to completely melt the fluorocarbon polymers; thus, coating the MDI cans with a uniform film. The prebaked-coated MDI cans are placed into a heated final baking oven. The temperature range for the final baking oven is usually about 350 to about 380° C., preferably any temperature within the range of about 360 to 375° C. The prebaked coated MDI cans are usually placed in the final baking oven for a time period of about 3.0 to about 9.75 minutes, preferably for about 5.0 to 9.0 minutes. The MDI cans are removed from the final baking oven into atmospheric air.

Full Bake

The term “full bake” defines the process comprised of a “prebake” followed by a “final bake.”

After baking, the melted fluorocarbon polymer coating requires time to cool. A “cooling station” allows the coated MDI cans to uniformly reach ambient temperature prior to packaging. The cooling station is preferably a single layer of MDI cans on a tray or a conveyor system.

Preferred Embodiment

All or part of internal surfaces of a metered dose inhaler are coated by applying a first coat comprising a fluorocarbon polymer to all or part of the internal the surfaces of a metered dose inhaler, then heating the first coat of fluorocarbon polymer. On top of the first coat of fluorocarbon polymer, a second coat of a fluorocarbon polymer is applied and then bakes the second coat of fluorocarbon polymer is heated.

Another embodiment has the first heating step as a prebake in the temperature range of about 100 to about 200° C. and the second heating step as a full bake comprised of a prebake in the temperature range of about 100 to about 200° C. for 1.0 to 5.0 minutes followed by a final bake in the temperature range of about 350 to about 380° C. for about 3.0 to about 9.75 minutes.

Another embodiment has the first heating step as a full bake comprised of a prebake in the temperature range of about 100 to about 200° C. for 1.0 to 5.0 minutes followed by a final bake in the temperature range of about 350 to about 380° C. for about 3.0 to about 9.75 minutes and the second heating step as a full bake comprised of a prebake in the temperature range of about 100 to about 200° C. for 1.0 to 5.0 minutes followed by a final bake in the temperature range of about 350 to about 380° C. for about 3.0 to about 9.75 minutes.

It will be apparent to those skilled in the art that modifications to the invention described herein can readily be made without departing from the spirit of the invention. Protection is sought for all the subject matter described herein including any such modifications.

The following non-limitive Examples serve to illustrate the invention.

Experimental Results

### EXAMPLE 1

Standard 12.5 ml MDI cans (Presspart Inc., Cary, N.C.) were placed in an annealing oven at a temperature of 230° C. for 3.5 minutes. The MDI can was spray-coated with FEP (DuPont 23484) to a coating thickness of about 5 μm and then placed in a prebaking oven at 170° C. for 3.5 minutes. A second coat of FEP was applied to the MDI can to a coating thickness of about 5 μm. The MDI can with the two coats was placed in a prebake oven at a temperature of 230° C. for 3.5 minutes, then placed in a final baking oven at a temperature of 370° C. for 7.5 minutes.

These cans were then purged of air, a metering valve crimped in place, and a suspension of about 24 mg Albuterol in about 18 gm P134A was filled through the valve.

### EXAMPLE 2

Standard 12.5 ml MDI cans (Presspart Inc., Cary, N.C.) were placed in an annealing oven at a temperature of 230° C. for 3.5 minutes. The MDI can was spray-coated with FEP (DuPont 23484) to a coating thickness of about 5 μm. The coated MDI can was placed in a prebaking oven at 170° C. for 3.5 minutes, then placed in a final baking oven at a temperature of 370° C. for 7.5 minutes. A second coat of FEP was applied to the MDI can to a coating thickness of about 5 μm. The MDI can with the two coats was placed in a prebake oven at a temperature of 230° C. for 3.5 minutes, then placed in a final baking oven at a temperature of 370° C. for 7.5 minutes. These cans were cooled, then purged of air, a metering valve crimped in place, and a suspension of about 24 mg Albuterol in about 18 gm P134A was filled through the valve.

### COMPARATIVE EXAMPLE

Standard 12.5 ml MDI cans (Presspart Inc., Cary, N.C.) were placed in an annealing oven at a temperature of 230° C. for 3.5 minutes. The MDI can was spray-coated with FEP (DuPont 23484) to a coating thickness of 5 μm. The coated MDI can was placed in a prebaking oven at 170° C. for 3.5 minutes, then placed in a final baking oven at a temperature of 370° C. for 7.5 minutes. These cans were cooled, then purged of air, a metering valve crimped in place, and a suspension of about 24 mg Albuterol in about 18 gm P134A was filled through the valve.

In Example 2 of the present invention, dose delivery from the MDIs cans were tested under simulated use conditions and found to reduce the amount of drug adhering MDI can surface, compared to control MDIs filled into single coat, single bake cans which exhibit a significant decrease in dose delivered through use. Tables 1 and 2 depict the results of a direct comparison between Example 2, Comparative Example 2 and control.

TABLE 1
Summary of Mean Drug Deposition on Can Wall, Valve and
drug in Suspension (mg) for SUT (Simulated Use Testing)

| Coating | Can Wall | Valve | Suspension |
|---|---|---|---|
| Example 2 | 0.35 | 2.92 | 1.48 |
| Comparative | 4.50 | 2.00 | 0.91 |
| Example | | | |
| Control (uncoated | 5.80 | 1.09 | 0.26 |
| aluminum can) | | | |

TABLE 2
Screening Parameter Experimental Results of Coatings
Evaluated in Final Phase Screening

| Screening Parameters | Example 2 | Comparative Example 2 |
|---|---|---|
| SUT Result (mcg) | Pass | Fail |
| Target ≧ 72 mcg | (69) | (43) |
| WACO¹ range | 0-6 | 492-494 |
| (milliamps) | | |
| Target < 25 milliamps | | |

¹WACO conductivity test for the detection of pinholes, per method MA1157, which is an internal GlaxoWellcome method. The Waco test measures the conductivity of the coating. If there are pinholes, less resistance is present to impede the current; thus, a higher current reading.

The results in Table 1 indicate that the present invention has significantly less drug coated on the can wall than the once coated Comparative Example and Control. The results in Table 2 indicate that the present invention has significantly less pin holes in the polymer film coating; therefore, the drug stays in suspension and does not adhere to the can wall. In particular, there are less pinholes in the coating for the drug to adhere to.

Example 1 was not tested for drug deposition, because the WACO test resulted in a high current reading.

What is claimed:

1. A method for coating all or part of internal surfaces of a metered dose inhaler, comprising:
applying a first coat comprising a fluorocarbon polymer to all or part of the internal the surfaces of a metered dose inhaler;
heating the first coat of fluorocarbon polymer;
applying a second coat comprising a fluorocarbon polymer on top of the first coat of fluorocarbon polymer; and
heating the second coat of fluorocarbon polymer.

2. The method according to claim 1, wherein the first heating step is a prebake and the second heating step is a full bake comprised of a prebake followed by a final bake.

3. The method according to claim 2, wherein the first heating step is a prebake in the temperature range of about 100 to about 200° C. and the second heating step is a full bake comprised of a prebake in the temperature range of about 100 to about 200° C. for 1.0 to 5.0 minutes followed by a final bake in the temperature range of about 350 to about 380° C. for about 3.0 to about 9.75 minutes.

4. The method according to claim 1, wherein the first heating step is a full bake comprised of a prebake followed by a final bake and the second heating step is a full bake comprised of a prebake followed by a final bake.

5. The method according to claim 4, wherein the first heating step is a full bake comprised of a prebake in the temperature range of about 100 to about 200° C. for 1.0 to 5.0 minutes followed by a final bake in the temperature range of about 350 to about 380° C. for about 3.0 to about 9.75 minutes and the second heating step is a full bake comprised of a prebake in the temperature range of about 100 to about 200° C. for 1.0 to 5.0 minutes followed by a final bake in the temperature range of about 350 to about 380° C. for about 3.0 to about 9.75 minutes.

6. The method according to claim 2, wherein the fluorocarbon polymer is fluorinated ethylene propylene polymers.

7. The method according to claim 4, wherein the fluorocarbon polymer is fluorinated ethylene propylene polymers.

8. A method for coating all or part of internal surfaces of a metered dose inhaler can, comprising:
annealing the surfaces of a metered dose inhaler can;
applying a first coat comprised of a fluorocarbon polymer to all or part of the internal the surfaces of a metered dose inhaler can;
full baking the first coat comprised of the fluorocarbon polymer;
applying a second coat comprised a fluorocarbon polymer on top of the first coat comprised of the fluorocarbon polymer;
full baking the two coats of fluorocarbon polymer; and
cooling the twice coated metered dose inhaler can.

9. The method according claim 8, wherein the full baking step consists essentially of a prebake in the temperature range of about 100 to about 200° C. for 1.0 to 5.0 minutes followed by a final bake in the temperature range of about 350 to about 380° C. for about 3.0 to about 9.75 minutes.

10. The method according to claim 8, wherein the fluorocarbon polymer is fluorinated ethylene propylene copolymer.

11. The method according to claim 1, wherein the metered dose inhaler is made of a metal or metal alloy comprising aluminum.

9. A metered dose inhaler can, comprising:
a can; and
two or more layers of polymer compositions coated on the inside of said can, each of said polymer compositions, which may be the same or different, comprising one or more fluorocarbon polymers, optionally in combination with one or more non-fluorocarbon polymers.

10. A metered dose inhaler, comprising:
the metered dose inhaler of claim 9;
a cap covering the mouth of said can;
a drug-metering valve situated on said cap; and
a drug formulation in said metered dose inhaler comprising an inhalation drug or a physiologically acceptable salt thereof and a fluorocarbon propellant.
